(19) United States
(12) Patent Application Publication
(10) Pub. No.: US 2017/0160552 A1
(43) Pub. Date: Jun. 8, 2017

(54) Vehicular Information Display Apparatus

(71) Applicant: TOYOTA JIDOSHA KABUSHIKI KAISHA, Toyota-shi (JP)

(72) Inventors: Shigeto MURAMATSU, Toyota-shi (JP); Hitoshi KUMON, Aichi-gun (JP)

(73) Assignee: TOYOTA JIDOSHA KABUSHIKI KAISHA, Toyota-shi (JP)

(21) Appl. No.: 15/362,069

(22) Filed: Nov. 28, 2016

(30) Foreign Application Priority Data
Dec. 7, 2015 (JP) 2015-238889

(51) Int. Cl. G02B 27/01; B60K 35/00; G06F 3/01

(52) U.S. Cl. CPC G02B 27/0179; G06F 3/011; G02B 27/0101; B60K 35/00; G02B 2027/014; G02B 2027/0183; B60K 2350/2052; B60K 2350/352; B60K 2350/92; B60K 2350/1076

(57) ABSTRACT

A vehicular information display apparatus includes: a head-up display unit and a controller configured to change an arrangement of information in the vehicle information image that includes vehicle information image that includes a first region, and a second region. The first region includes a first image portion representing current vehicle speed information. The first image portion includes a vehicle speed value display representing a vehicle speed value, and a unit display representing a unit of the vehicle speed value. The controller is configured to set a position of the vehicle speed value display such that the position of the vehicle speed value is left-aligned in the first region, and configured to change a position of the unit display to a position directly below a rightmost numeral of the vehicle speed value display.

### INCORPORATION BY REFERENCE

The disclosure of Japanese Patent Application No. 2015-238889 filed on Dec. 7, 2015 including the specification, drawings and abstract is incorporated herein by reference in its entirety.

### BACKGROUND

1. Technical Field

The disclosure relates to a vehicular information display apparatus.

2. Description of Related Art

A head-up display unit that displays a vehicle information image in the driver's forward field of view is known (see, for example, Japanese Patent Application Publication No. 2015-141161 (JP 2015-141161 A)). The vehicle information image includes a plurality of image portions respectively representing different kinds of vehicle information, such as a vehicle speed and route guidance information.

The size of the vehicle information image displayed, by the head-up display unit, in the driver's forward field of view is restricted due to, for example, the restriction on the size of the head-up display unit itself.

From this point of view, the related art as described in JP 2015-141161 A is hard to realize under the condition that the size of a vehicle information image is limited. This is because the vehicle information image includes a plurality of image portions.

### SUMMARY

Meanwhile, when the image portions are arranged adjacent to one another in the vehicle information image under the condition that the size of the vehicle information image is limited, a space (blank area) between the adjacent image portions is relatively narrow. In this case, the readability of each image portion may be reduced, or the driver's view through the space may be obstructed.

There may be a configuration in which a head-up display unit displays a vehicle information image in which a first image portion representing a vehicle speed and a second image portion representing vehicle information other than the vehicle speed are disposed adjacent to each other in the right-left direction, and the first image portion includes a vehicle speed value display representing a vehicle speed value in an integer representation and a unit display representing the unit of the vehicle speed value. In such a configuration, when the number of digits of the vehicle speed value changes in response to a change in the vehicle speed, the size of a space, in the right-left direction, required to dispose the first image portion in the vehicle information image changes. For example, when the vehicle speed is 0 km/h, the number of digits of the vehicle speed value is one, whereas when the vehicle speed is 100 km/h, the number of digits of the vehicle speed value is three. Therefore, the space for the first image portion in the vehicle information image is narrower when the number of digits of the vehicle speed value is one than when the number of digits of the vehicle speed value is three. This means that, the space in the right-left direction between the first image portion and the second image portion can be made wider when the number of digits of the vehicle speed value is one, than when the number of digits of the vehicle speed value is three. Further, from the viewpoint of increasing the space in the right-left direction between the first image portion and the second image portion, disposing the unit display at a position below the vehicle speed value display is more than disposing the unit display between the vehicle speed value display and the second image portion.

The disclosure provides a vehicular information display apparatus including a head-up display unit configured to display a vehicle information image in which a first image portion and a second image portion are disposed adjacent to each other in the right-left direction, the vehicular information display apparatus configured to inhibit reduction in the readability of the first image portion and the second image portion and obstruction of the driver's view.

An aspect of the disclosure relates to a vehicular information display apparatus including: a head-up display unit configured to generate a vehicle information image relating to vehicle information, and to display the vehicle information image on a front windshield glass disposed in front of a driver; and a controller configured to change an arrangement of information in the vehicle information image. The vehicle information image includes a first region, and a second region disposed at a position adjacent to and on a right side of the first region. The first region includes a first image portion representing current vehicle speed information. The second region includes a second image portion representing vehicle information different from the vehicle speed information. The first image portion includes a vehicle speed value display representing a vehicle speed value that is an integer value, and a unit display representing a unit of the vehicle speed value. The controller is configured to set a position of the vehicle speed value display such that the position of the vehicle speed value is left-aligned in the first region, and configured to change a position of the unit display to a position directly below a rightmost numeral of the vehicle speed value display in response to a change in the number of digits of the vehicle speed value.

In the above aspect, the controller changes the arrangement of information in the vehicle information image. The vehicle information image includes the first region and the second region disposed adjacent to each other in the right-left direction. The first region includes the first image portion representing the current vehicle speed, and the second region includes the second image portion representing the vehicle information different from the vehicle speed information. The first image portion includes the vehicle speed value display representing the vehicle speed value that is an integer value, and the unit display representing the unit of the vehicle speed value. The space required for the vehicle speed value display changes in response to a change in the number of digits of the vehicle speed value. Therefore, the position of the vehicle speed value display is left-aligned in the first region, whereby a space on the right side in the first region can be made wider when the number of digits of the vehicle speed value is one or two. Thus, when the number of digits of the vehicle speed value is one or two, the space in the right-left direction between the vehicle speed value display in the first region and the display of the second image portion in the second region can be made wider. As a result, it is possible to improve the readability of these displays and to reduce obstruction of the driver's view. When the position of the vehicle speed value display is left-aligned in the first region, setting the position of the unit display to a position on the right side of the vehicle speed value display in the first region is disadvantageous from the viewpoint of widening the space. In view of this, in the above aspect of the disclosure, the position of the unit display is changed to a position directly below the rightmost numeral of the vehicle speed value display in response to a change in the number of digits of the vehicle speed value. Therefore, according to the above aspect of the disclosure, it is possible to make the space wider than that when the position of the unit display is on the right side of the vehicle speed value display in the first region, thereby reducing obstruction of the driver's view. In addition, according to the above aspect of the disclosure, the position of the unit display is changed to a position directly below the rightmost numeral of the vehicle speed value display in response to a change in the number of digits of the vehicle speed value. Therefore, even when the number of digits of the vehicle speed value changes, it is possible to maintain a high visibility of the vehicle speed value display.

According to the disclosure, in the vehicular information display apparatus including the head-up display unit configured to display a vehicle information image in which the first image portion and the second image portion are disposed adjacent to each other in the right-left direction, it is possible to inhibit reduction in the readability of the first image portion and the second image portion and obstruction of the driver's view.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a vehicle system relating to a vehicular information display apparatus;

FIG. 2 is a sectional view schematically showing an example of a head-up display (HUD) unit;

FIG. 3 is a view schematically showing an example of a display state of a vehicle information image displayed by the HUD unit;

FIG. 4 is an explanatory diagram of respective regions of the vehicle information image;

FIG. 5 is a view showing an example of a vehicle speed image portion;

FIG. 6 is a functional block diagram of a display controller;

FIG. 7 is a flowchart showing an example of processing executed by the display controller;

FIG. 8 is a view schematically showing the relationship between a display image and a vehicle information image;

FIG. 9A is a view showing an example of a vehicle information image when a vehicle speed value has one digit according to an embodiment;

FIG. 9B is a view showing an example of a vehicle information image when a vehicle speed value has two digits according to the embodiment;

FIG. 9C is a view showing an example of a vehicle information image when a vehicle speed value has three digits according to the embodiment;

FIG. 10A is a view showing an example of a vehicle information image when a vehicle speed value has one digit according to a comparative example;

FIG. 10B is a view showing an example of a vehicle information image when a vehicle speed value has two digits according to the comparative example; and

FIG. 10C is a view showing an example of a vehicle information image when a vehicle speed value has three digits according to the comparative example.

### DETAILED DESCRIPTION OF EMBODIMENTS

Hereinafter, an example embodiment of the disclosure will be described with reference to the accompanying drawings.

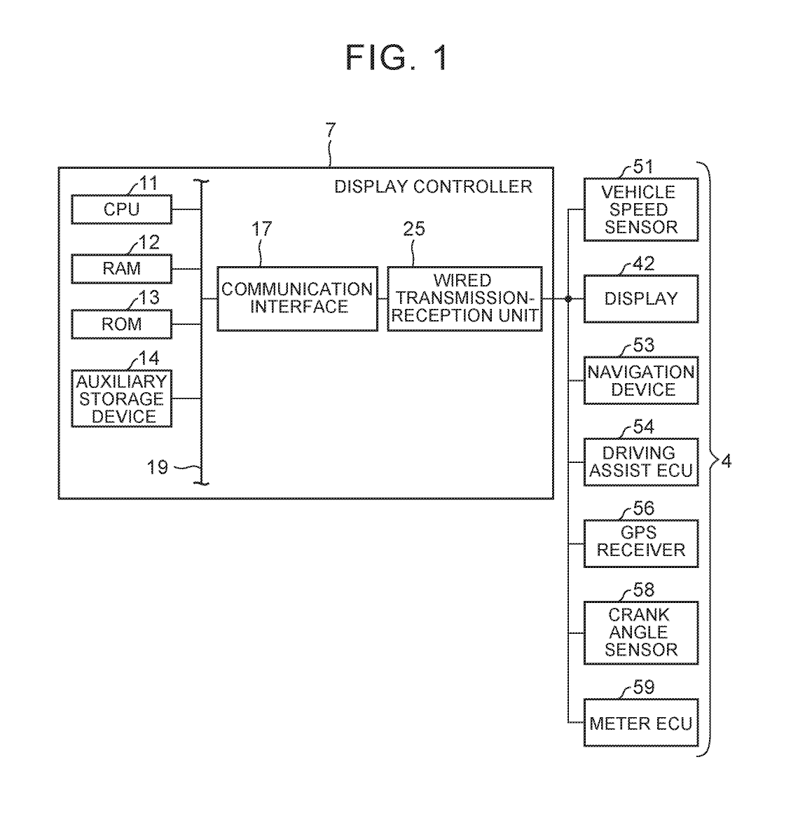

FIG. 1 is a diagram showing an example of a vehicle system relating to a vehicular information display apparatus. FIG. 1 also shows the hardware configuration of a display controller 7.

The vehicle system is mounted in a vehicle. The vehicle is a right-hand drive vehicle. The vehicle system includes an in-vehicle electronic device group 4 and the display controller 7.

The in-vehicle electronic device group 4 includes, for example, a display device (projector) 42, a vehicle speed sensor 51, a navigation device 53, a driving assist electronic control unit (ECU) 54, a global positioning system (GPS) receiver 56, a crank angle sensor 58, and a meter electronic control unit (ECU) 59.

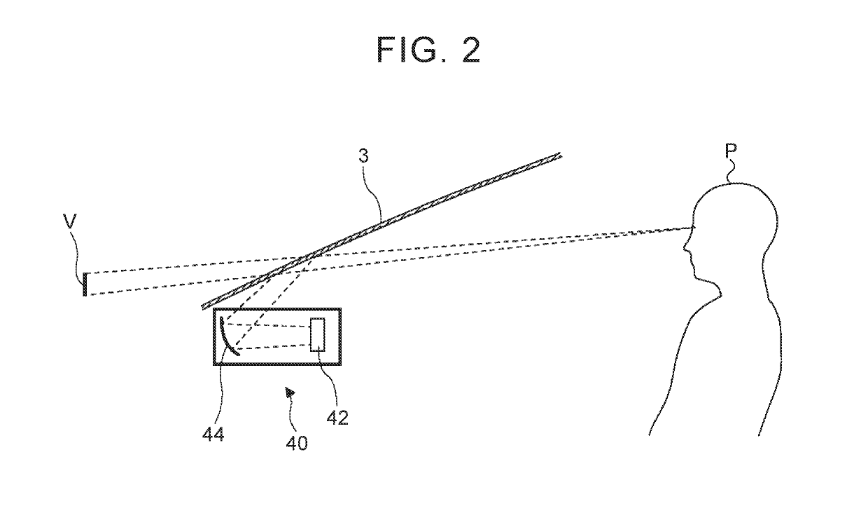

The display device 42 is incorporated in a head-up display (HUD) unit 40. An example of the HUD unit 40 will be described with reference to FIG. 2.

The vehicle speed sensor 51 outputs an electrical signal corresponding to a wheel speed (vehicle speed pulse).

The navigation device 53 generates route guidance information based on the host vehicle position information obtained from the GPS receiver 56 and the map information.

The driving assist ECU 54 includes an electronic control unit (ECU) that executes adaptive cruise control (ACC), and an electronic control unit (ECU) that executes lane keeping assist (LKA). The ACC and the LKA are known, and thus description thereof will be omitted. The driving assist ECU 54 generates control state information (an example of vehicle information) relating to the control states of the ACC and the LKA.

The GPS receiver 56 determines a host vehicle position based on signals from GPS satellites.

The crank angle sensor 58 detects a crank angle of an internal combustion engine.

The meter ECU 59 controls the display on a meter disposed on an instrument panel. Based on the information from the vehicle speed sensor 51, the meter ECU 59 calculates, in integer values (0 to 180), a vehicle speed value to be displayed on a speedometer portion of the meter. Based on the information from the crank angle sensor 58, the meter ECU 59 calculates an engine speed to be displayed on a tachometer portion of the meter.

The display controller 7 includes a central processing unit (CPU) 11, a random-access memory (RAM) 12, a read-only memory (ROM) 13, an auxiliary storage device 14, and a communication interface 17 that are connected to one another through a bus 19, and a wired transmission-reception unit 25 connected to the communication interface 17.

The display controller 7 sends an image signal to the HUD unit 40, thereby causing the HUD unit 40 to display a vehicle information image in the driver's forward field of view. The vehicle information image and the like will be described later in detail.

FIG. 2 is a sectional view schematically showing an example of the HUD unit 40. As shown in FIG. 2, the HUD unit 40 is provided, for example, in the instrument panel. In the present embodiment, the HUD unit 40 and the display controller 7 constitute an example of the vehicular information display apparatus.

The HUD unit 40 includes the display device 42. The display device 42 generates visible light (display light) for transmitting information to the driver. The display light is generated based on an image signal sent from the display controller 7. The display device 42 emits the display light for a vehicle information image 70 (described below in detail) under the control by the display controller 7.

The display light projected from the display device 42 reaches an image projection surface of a front windshield glass 3. The display light is diffracted in a direction toward the driver by the image projection surface of the front windshield glass 3. Thus, the vehicle information image is displayed in the driver's forward field of view in the form of a virtual image V. In FIG. 2, a projection range (optical path) of the display light with respect to a driver P (more specifically, the position of the eyes of the driver P) is indicated by dotted lines. In the example shown in FIG. 2, the HUD unit 40 includes a concave mirror 44, and the display light projected from the display device 42 is reflected from the concave mirror 44 and then reaches the image projection surface of the front windshield glass 3.

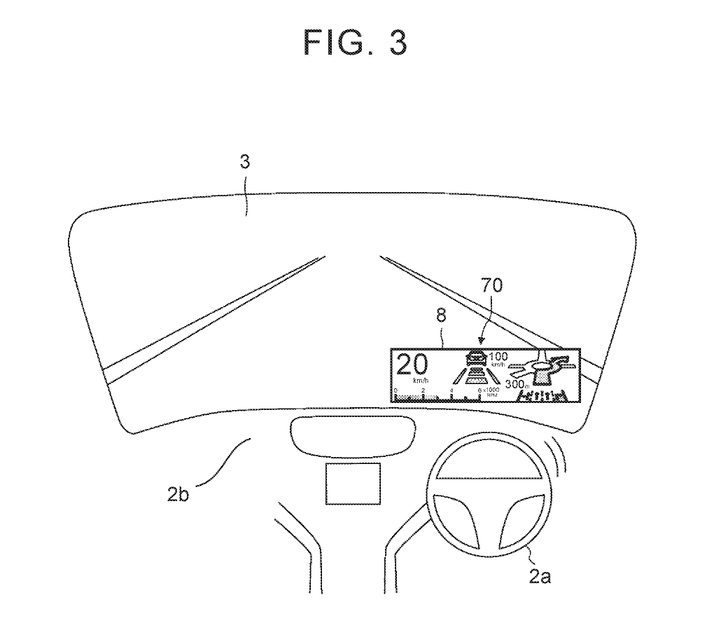

FIG. 3 is a view schematically showing an example of a display state of the vehicle information image 70 displayed by the HUD unit 40. FIG. 3 shows a steering wheel 2a and an instrument panel 2b, and also shows a display state of the vehicle information image 70 from the point of view of the driver. In FIG. 3, a frame display 8 in the vehicle information image 70 may be omitted. The details of the vehicle information image 70 will be described below in detail.

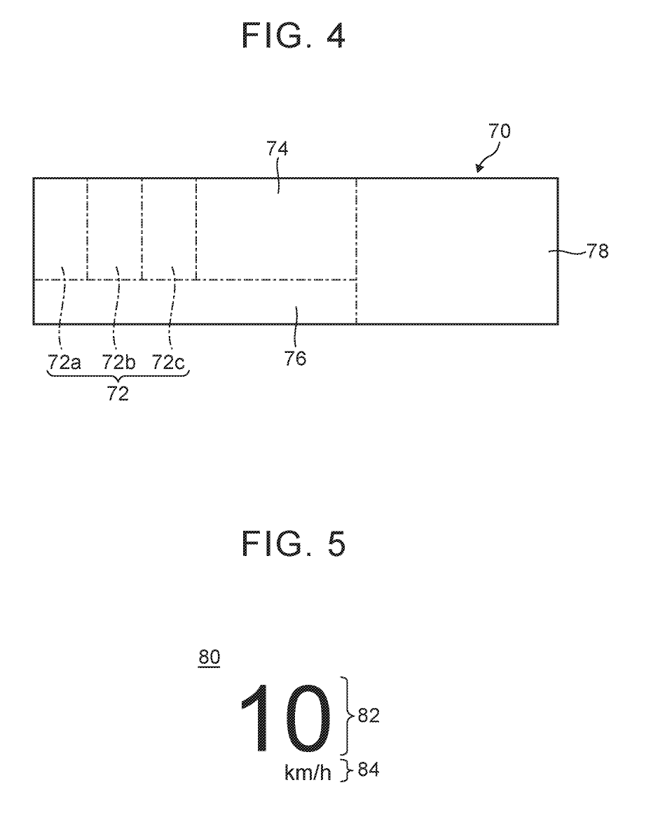

FIG. 4 is an explanatory diagram of a region of the vehicle information image 70. In the following description, the right-left direction and the up-down direction are directions as viewed from the driver, and the right-left direction coincides with the vehicle-width direction (see FIG. 3).

The vehicle information image 70 includes image portions that are disposed in respective regions and that respectively provide different kinds of information. That is, the region of the vehicle information image 70 is defined by a combination of the regions including the respective image portions.

In an example shown in FIG. 4, the vehicle information image 70 includes a first region 72, a second region 74, a third region 76, and a fourth region 78. The boundaries of the regions 72, 74, 76, 78 are fixed.

The first region 72 is disposed in the leftmost portion of the vehicle information image 70. As shown in FIG. 4, the first region 72 includes segmented regions 72a, 72b, 72c that are obtained by dividing the first region 72 into three segments in the right-left direction. Hereinafter, the segmented regions 72a, 72b, 72c will be respectively referred to as a “left region 72a”, a “central region 72b”, and a “right region 72c”.

The second region 74 is disposed at a position adjacent to and on the right side of the first region 72. The second region 74 is disposed at substantially the center of the vehicle information image 70.

The third region 76 is disposed below the first region 72 and the second region 74.

The fourth region 78 is disposed in the rightmost portion of the vehicle information image 70.

FIG. 5 is a view showing an example of a vehicle speed image portion 80.

The vehicle speed image portion 80 (an example of a first image portion) is an image portion in the first region 72 of the vehicle information image 70. As shown in FIG. 5, the vehicle speed image portion 80 includes a vehicle speed value display 82 representing a vehicle speed value in an integer representation and a unit display 84 representing the unit of the vehicle speed value. The size of a numeral in each digit of the vehicle speed value display 82 does not change (is kept constant) even when the number of digits of the vehicle speed value changes. The width of the vehicle speed value display 82 changes in response to a change in the number of digits of the vehicle speed value as described below.

The unit display 84 is disposed below the vehicle speed value display 82. Specifically, the unit display 84 is disposed directly below the rightmost numeral of the vehicle speed value display 82.

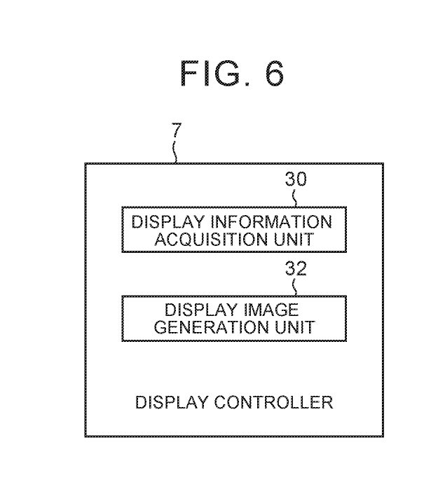

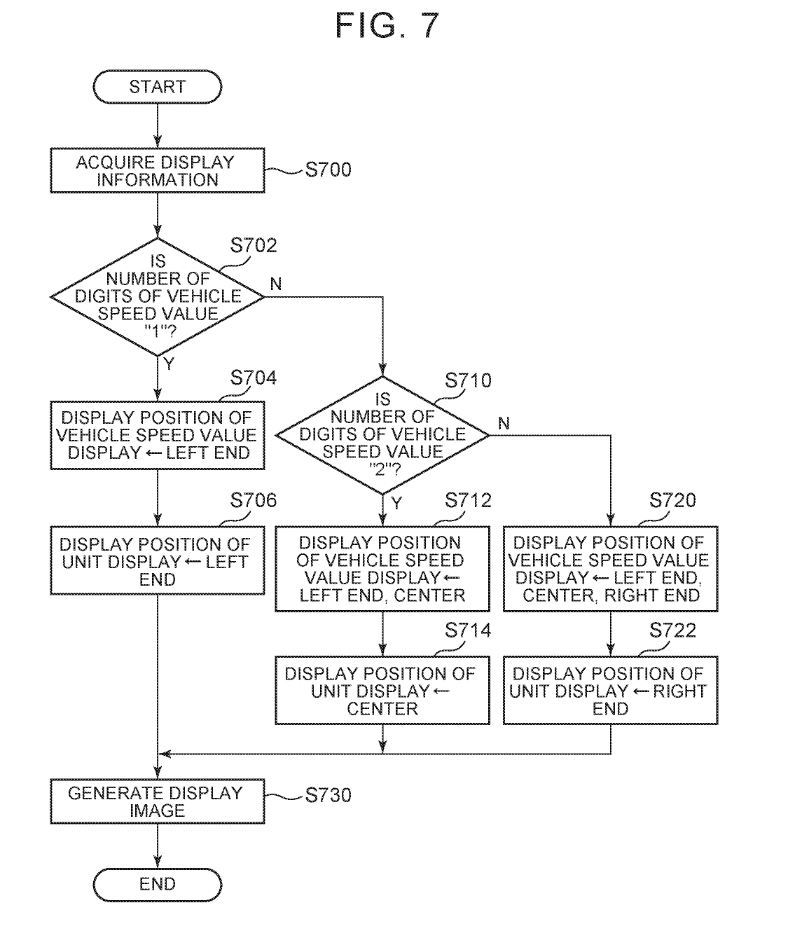

FIG. 6 is a functional block diagram of the display controller 7. As shown in FIG. 6, the display controller 7 includes a display information acquisition unit 30 and a display image generation unit 32. The display information acquisition unit 30 and the display image generation unit 32 can be implemented when the CPU 11 shown in FIG. 1 executes one or more programs stored in, for example, the ROM 13. The functions of the display information acquisition unit 30 and the display image generation unit 32 will be described below with reference to, for example, FIG. 7.

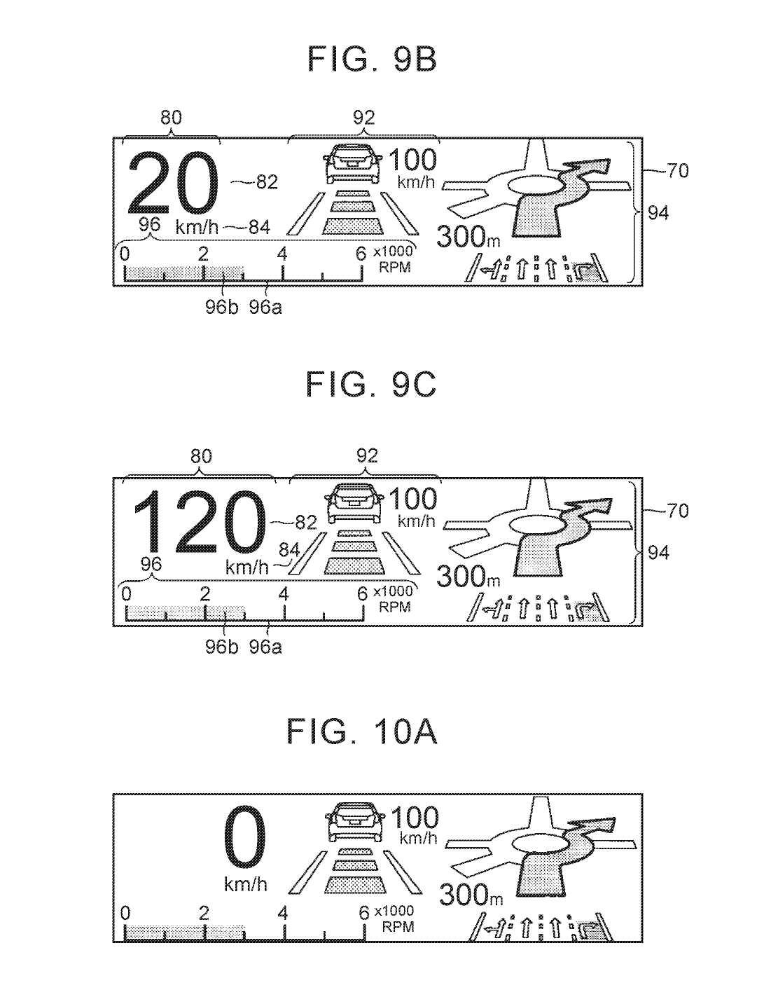

Next, the operation and the like of the display controller 7 will be described with reference to FIG. 7 and FIGS. 9A to 9C.

FIG. 7 is a flowchart showing an example of processing executed by the display controller 7. The processing shown in FIG. 7 is activated when the display function of the HUD unit 40 is turned on, and is repeatedly executed at predetermined intervals while the display function of the HUD unit 40 is in an on-state.

In Step S700, the display information acquisition unit 30 acquires display information. The display information includes vehicle speed information, control state information, route guidance information, and engine speed information. The vehicle speed information and the engine speed information can be acquired from the meter ECU 59. The control state information can be acquired from the driving assist ECU 54. The route guidance information can be acquired from the navigation device 53.

In Step S702, the display image generation unit 32 determines whether or not the number of digits of a vehicle speed value is one based on the vehicle speed information acquired in Step S700. When an affirmative determination is made in step S702, the process proceeds to Step S704. On the other hand, when a negative determination is made in step S702, the process proceeds to Step S710.

In Step S704, the display image generation unit 32 sets the display position of the vehicle speed value display 82, at the leftmost portion of the vehicle information image 70, that is, at the left region 72a (see FIG. 4 and FIG. 9A). The display image generation unit 32 sets the display position of the vehicle speed value display 82 such that the numeral in the ones place is disposed in the left region 72a.

In Step S706, the display image generation unit 32 sets the display position of the unit display 84, at the left region 72a. In this case, the display position of the unit display 84 is set at a lower portion of the left region 72a (see FIG. 4 and FIG. 9A).

In Step S710, the display image generation unit 32 determines whether or not the number of digits of the vehicle speed value is two based on the vehicle speed information acquired in Step S700. When an affirmative determination is made in step S710, the process proceeds to Step S712. On the other hand, when a negative determination is made in step S710, the process proceeds to Step S720.

In Step S712, the display image generation unit 32 sets the display position of the vehicle speed value display 82, at the leftmost portion and the central portion of the vehicle information image 70, that is, at the left region 72a and the central region 72b (see FIG. 4 and FIG. 9B). Specifically, the display image generation unit 32 sets the display position of the vehicle speed value display 82 such that the numeral in the ones place is disposed in the central region 72b and the numeral in the tens place is disposed in the left region 72a.

In Step S714, the display image generation unit 32 sets the display position of the unit display 84, at the central region 72b. In this case, the display position of the unit display 84 is set at a lower portion of the central region 72b (see FIG. 4 and FIG. 9B).

In Step S720, the display image generation unit 32 sets the display position of the vehicle speed value display 82, at the leftmost portion, the central portion, and the rightmost portion of the vehicle information image 70, that is, at the left region 72a, the central region 72b, and the right region 72c (see FIG. 4 and FIG. 9C). Specifically, the display image generation unit 32 sets the display position of the vehicle speed value display 82 such that the numeral in the ones place is disposed in the right region 72c, the numeral in the tens place is disposed in the central region 72b, and the numeral in the hundreds place is disposed in the left region 72a.

In Step S722, the display image generation unit 32 sets the display position of the unit display 84, at the right region 72c. In this case, the display position of the unit display 84 is set at a lower portion of the right region 72c (see FIG. 4 and FIG. 9C).

In Step S730, the display image generation unit 32 generates a display image portion corresponding to the vehicle speed image portion 80 based on the setting results, generates display image portions corresponding to other image portions of the vehicle information image 70, and generates a display image in which the display image portions are combined together. The display image generation unit 32 sends an image signal corresponding to the generated display image to the HUD unit 40. Then, the processing in the present cycle ends. The other image portions of the vehicle information image 70 include a control state image portion 92 (an example of a second image portion) in the second region 74, an engine speed image portion 96 (an example of a third image portion) in the third region 76, and a navigation information image portion 94 in the fourth region 78 (see FIG. 9A). A display image portion corresponding to the control state image portion 92 is generated based on the control state information acquired in Step S700. A display image portion corresponding to the engine speed image portion 96 is generated based on the engine speed information acquired in Step S700. A display image portion corresponding to the navigation information image portion 94 is generated based on the route guidance information acquired in Step S700.

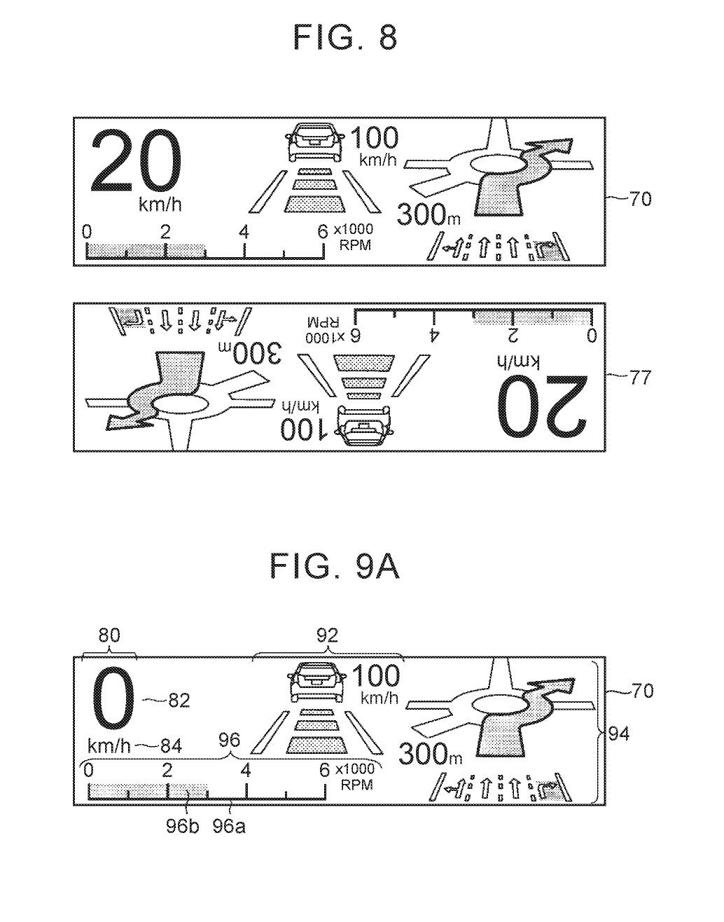

As shown in FIG. 8, due to the presence of the concave mirror 44, display image 77 generated by the display image generation unit 32 and the vehicle information image 70 displayed in the driver's forward field of view have an up-down and right-left inverted relation, that is, the vehicle information image 70 results from rotating the display image 77 180 degrees. In the description of this specification, as described above, “up, down, right, left” relating to the vehicle information image is “up, down, right, left” when the vehicle information image is viewed from the driver.

According to the processing shown in FIG. 7, the display image generation unit 32 can left-align (left-justify) the position of the vehicle speed value display 82 in the first region 72, and can change the position of the unit display 84 to a position directly below the rightmost numeral of the vehicle speed value display 82 in response to a change in the number of digits of the vehicle speed value.

FIGS. 9A to 9C are views each showing an example of the vehicle information image 70 that can be generated through the processing shown in FIG. 7. FIG. 9A shows an example of the vehicle information image 70 when the vehicle speed value has one digit. FIG. 9B shows an example of the vehicle information image 70 when the vehicle speed value has two digits. FIG. 9C shows an example of the vehicle information image 70 when the vehicle speed value has three digits.

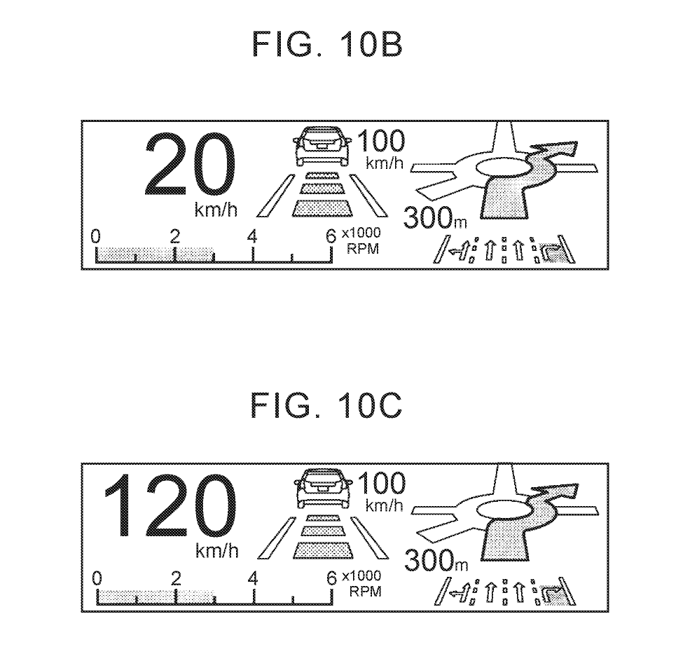

FIGS. 10A to 10C are views each showing a vehicle information image according to a comparative example. FIG. 10A shows an example of the vehicle information image when the vehicle speed value has one digit. FIG. 10B shows an example of the vehicle information image when the vehicle speed value has two digits. FIG. 10C shows an example of the vehicle information image when the vehicle speed value has three digits.

In the comparative example, unlike the present embodiment, as shown in FIGS. 10A to 10C, the position of the vehicle speed value display is right-aligned (right-justified) in the first region, and the position of the unit display is fixed to a position directly below the rightmost numeral of the vehicle speed value display regardless of the number of digits of the vehicle speed value.

In such a comparative example, even when the vehicle speed value has one digit or two digits, a space (blank area) in the right-left direction between the vehicle speed image portion 80 and the control state image portion 92 is relatively narrow. Thus, the readability of the vehicle speed image portion 80 and the control state image portion 92 may be reduced, or the driver's view may be obstructed.

In view of this, according to the processing shown in FIG. 7, the position of the vehicle speed value display 82 is left-aligned in the first region 72. Thus, as shown in FIGS. 9A to 9C, it is possible to keep a wider space in the right-left direction between the vehicle speed image portion 80 and the control state image portion 92 when the vehicle speed value has one digit, than when the vehicle speed value has two digits or three digits. Similarly, as shown in FIG. 9B and FIG. 9C, it is possible to keep a wider space in the right-left direction between the vehicle speed image portion 80 and the control state image portion 92 when the vehicle speed value has two digits, than when the vehicle speed value has three digits. Thus, when the vehicle speed value has one digit or two digits, the readability of the vehicle speed image portion 80 and the control state image portion 92 is improved. In particular, because a region in which the vehicle speed value has one digit or two digits is a regular region, it is possible to improve the readability in the regular region.

According to the processing shown in FIG. 7, the position of the unit display 84 is changed to a position directly below the rightmost numeral of the vehicle speed value display 82 in response to a change in the number of digits of the vehicle speed value. Thus, it is possible to increase the visibility of the information represented by the vehicle speed image portion 80. This is because setting the unit at a position corresponding to the last digit of a numerical value is advantageous from the viewpoint of visibility. Even if the unit display 84 is disposed, for example, on the right side of the vehicle speed value display 82, it is possible to increase the visibility of the information represented by the vehicle speed image portion 80; however, in this case, the space in the right-left direction between the vehicle speed image portion 80 and the control state image portion 92 becomes narrower accordingly.

As described above, according to the present embodiment, when the vehicle speed value has one digit or two digits, it is possible to keep a wide space in the right-left direction between the vehicle speed image portion 80 and the control state image portion 92, thereby reducing the inconveniences, such as reduction in the readability of the vehicle speed image portion 80 and the control state image portion 92 and obstruction of the driver's view that may occur if the space is relatively narrow. According to the present embodiment, the position of the unit display 84 is set to a position below the vehicle speed value display 82, and thus it is possible to keep a wide space in the right-left direction between the vehicle speed image portion 80 and the control state image portion 92, thereby reducing the inconveniences that may occur if the space is relatively narrow. According to the present embodiment, the position of the unit display 84 is changed to a position directly below the rightmost numeral of the vehicle speed value display 82 in response to a change in the number of digits of the vehicle speed value, and thus it is possible to increase the visibility of the information represented by the vehicle speed image portion 80 over the entire range of the vehicle speed values.

In the examples shown in FIGS. 9A to 9C, the control state image portion 92 includes a display indicating a preceding vehicle, a display indicating a lane, and a display indicating a set vehicle speed. The navigation information image portion 94 includes a display indicating a road shape, a display indicating lanes, a display indicating a distance (in this example, 300 m) to a course change point, such as a right/left turn point, and a display indicating a course change direction. The engine speed image portion 96 includes a graduation display 96a extending in the right-left direction, and a display 96b indicating a current value.

According to the example shown in FIGS. 9A to 9C, the origin position of the graduation display 96a is disposed below the left region 72a (see FIG. 4). Further, the vehicle speed value display 82 is left-aligned. Thus, even when the number of digits of the vehicle speed value changes, the leftmost position of the vehicle speed value display 82 and the origin position of the graduation display 96a are left-aligned (flush left). Thus, it is possible to keep fine appearance over the entire range of the vehicle speed values. Even when the number of digits of the vehicle speed value changes, the positional relationship between the leftmost position of the vehicle speed value display 82 and the origin position of the graduation display 96a does not change. Thus, it is possible to maintain continuity over the entire range of the vehicle speed values, and, as a result, the ease of viewing both the vehicle speed value display 82 and the graduation display 96a is improved.

While the example embodiment of the disclosure has been described above in detail, the disclosure is not limited to the above-described embodiment, and various modifications and changes may be made to the above-described embodiment within the scope of the disclosure.

For example, in the above-described embodiment, the vehicle information image 70 includes the control state image portion 92 representing the control state information in the second region 74. However, the disclosure is not limited to this configuration. For example, the vehicle information image 70 may include an image portion representing another kind of vehicle information in the second region 74. The vehicle information may be any kind of information relating to the vehicle, and includes, for example, device information representing the states of various in-vehicle devices (for example, an air-conditioner), behavior information representing the behavior of the vehicle, status information representing the status of the vehicle, such as instantaneous fuel efficiency or a state of charge (SOC) of a battery, information relating to the weather around the vehicle, and driving assist information for assisting driving by the driver. The route guidance information represented by the navigation information image portion 94 is also the driving assist information and is included in the concept of the vehicle information. Therefore, in the vehicle information image 70, the navigation information image portion 94 representing the route guidance information may be disposed at a position adjacent to and on the right side of the vehicle speed image portion 80. In this case, the navigation information image portion 94 is an example of a second image portion. The engine speed represented by the engine speed image portion 96 is the device information, and is included in the concept of the vehicle information. Therefore, in the vehicle information image 70, the engine speed image portion 96 representing the engine speed may be disposed at a position adjacent to and on the right side of the vehicle speed image portion 80. In this case, the engine speed image portion 96 is an example of a second image portion.

In the above-described embodiment, the HUD unit 40 includes the concave mirror 44. Instead of the HUD unit 40, a HUD unit having no concave mirror 44, or a HUD unit having another mirror in addition to the concave mirror 44 may be used. When a HUD unit having no concave mirror 44 is used, the display image 77 and the vehicle information image 70 have an up-down inverted relation (no inversion in the up-down direction).

In the above-described embodiment, the vehicle is a right-hand drive vehicle. Alternatively, the vehicle may be a left-hand drive vehicle. In the case of the left hand drive vehicle, the “right-left” relationship with respect to the point of view of the driver is the same as that in the above description.

In regard to the above-described embodiment, the following disclosure is further provided. A first disclosure provides a vehicular information display apparatus including the HUD unit 40 that projects display light toward the front windshield glass 3, and the display controller 7 that causes the HUD unit 40 to display a vehicle information image. When the right-left direction is defined as a direction as viewed from the driver, the vehicle information image includes a first image portion representing a current vehicle speed in the first region 72 disposed in the leftmost portion of the vehicle information image and a second image portion representing vehicle information different from the current vehicle speed in the second region 74 disposed at a position adjacent to and on the right side of the first region 72, the first image portion includes the vehicle speed value display 82 representing a vehicle speed value in an integer representation and the unit display 84 representing the unit of the vehicle speed value, and the display controller 7 is configured to set the position of the vehicle speed value display 82 such that the position of the vehicle speed value display 82 is left-aligned in the first region 72, and configured to change the position of the unit display 84 to a position directly below the rightmost numeral of the vehicle speed value display 82 in response to a change in the number of digits of the vehicle speed value.

According to a second disclosure, in the vehicular information display apparatus described in the first disclosure, the first region 72 includes the three segmented regions 72a, 72b, 72c, which are obtained by dividing the first region 72 into three segments in the right-left direction, and the display controller 7 is configured to set the position of the vehicle speed value display 82 at the leftmost segmented region 72a when the number of digits of the vehicle speed value is one, configured to set the position of the vehicle speed value display 82 at the leftmost segmented region 72a and the central segmented region 72b when the number of digits of the vehicle speed value is two, and configured to set the position of the vehicle speed value display 82 at the three segmented regions 72a, 72b, 72c when the number of digits of the vehicle speed value is three.

According to a third disclosure, in the vehicular information display apparatus described in the second disclosure, when the up-down direction is defined as a direction as viewed from the driver, the vehicle information image further includes a third image portion representing the current engine speed in the third region 76 disposed at a position adjacent to and below the first region 72, the third image portion includes the graduation display 96a extending in the right-left direction, and the origin position of the graduation display 96a is below the leftmost segmented region 72a.

According to the third disclosure, the position of the vehicle speed value display 82 of the first image portion and the origin position of the graduation display 96a of the third image portion are left-aligned, and the ease of viewing the vehicle information image and the appearance of the vehicle information image are improved.

What is claimed is:

1. A vehicular information display apparatus comprising:
a head-up display unit configured to generate a vehicle information image relating to vehicle information, and to display the vehicle information image on a front windshield glass disposed in front of a driver; and
a controller configured to change an arrangement of information in the vehicle information image, wherein
the vehicle information image includes a first region, and a second region disposed at a position adjacent to and on a right side of the first region, the first region includes a first image portion representing current vehicle speed information, and the second region includes a second image portion representing vehicle information different from the vehicle speed information,
the first image portion includes a vehicle speed value display representing a vehicle speed value that is an integer value, and a unit display representing a unit of the vehicle speed value, and
the controller is configured to set a position of the vehicle speed value display such that the position of the vehicle speed value is left-aligned in the first region, and configured to change a position of the unit display to a position directly below a rightmost numeral of the vehicle speed value display in response to a change in the number of digits of the vehicle speed value.

2. The vehicular information display apparatus according to claim 1, wherein:
the first region is divided into three segments in a right-left direction such that the first region includes a left region disposed on a left side in the first region, a central region disposed at a center of the first region, and a right region disposed on a right side in the first region; and
the controller is configured to set the position of the vehicle speed value display at the left region when the number of digits of the vehicle speed value is one, configured to set the position of the vehicle speed value display at the left region and the central region when the number of digits of the vehicle speed value is two, and configured to set the position of the vehicle speed value display at the left region, the central region, and the right region when the number of digits of the vehicle speed value is three.

3. The vehicular information display apparatus according to claim 2, wherein:
the vehicle information image further includes a third region disposed at a position adjacent to and below the first region, and the third region includes a third image portion representing a current engine speed; and
the third image portion includes a graduation display extending in the right-left direction, and an origin position of the graduation display is below the left region.

4. The vehicular information display apparatus according to claim 1, wherein, in the vehicle information image, a blank area between the first image portion and the second image portion is wider when the vehicle speed value has one digit or two digits than when the vehicle speed value has three digits.

5. The vehicular information display apparatus according to claim 1, wherein the first region is disposed in a leftmost portion of the vehicle information image.

6. The vehicular information display apparatus according to claim 1, wherein:
the controller includes a central processing unit, a random-access memory, a read-only memory, an auxiliary storage device, and a communication interface connected to one another, and a wired transmission-reception unit connected to the communication interface; and
the controller is configured to acquire the vehicle speed information and vehicle information different from the vehicle speed information, and configured to generate a display image in which the first image portion and the second image portion are combined together.
